(19) United States
(12) Patent Application Publication
(10) Pub. No.: US 2022/0312824 A1
(43) Pub. Date: Oct. 6, 2022

(54) System and Method for Preparing Hemp for Rolling Hemp Cigarettes

(71) Applicant: East Coast Genetics, North Huntington, PA (US)

(72) Inventor: Thomas R. Ryan, North Huntingdon, PA (US)

(21) Appl. No.: 17/708,107

(22) Filed: Mar. 30, 2022

Related U.S. Application Data
(60) Provisional application No. 63/167,923, filed on Mar. 30, 2021.

(51) Int. Cl. A24B 3/18; A24B 3/07; A24B 9/00; A24C 5/10; A24D 1/18

(52) U.S. Cl. CPC A24B 3/18; A24B 3/07; A24B 9/00; A24C 5/10; A24D 1/18; B07B 1/00

(57) ABSTRACT

A system and method for preparing hemp for rolling hemp cigarettes may trim bucked hemp including dried and cured leaves and flowers of hemp plants to generate trimmed hemp, kief the trimmed hemp to generate kiefed hemp, filter the kiefed hemp to generate rolling hemp, and provide the rolling hemp for rolling hemp cigarettes.

### CROSS-REFERENCE TO RELATED APPLICATION

This application claims priority to U.S. Provisional Application No. 63/167,923, filed Mar. 30, 2021, the disclosure of which is hereby incorporated by reference in its entirety.

### BACKGROUND

Conventional methods for preparing hemp for rolling hemp cigarettes provide a product that is not prepared in a consistent manner, is not sufficiently compressed to enable air to be drawn through the hemp when lit to burn evenly, is not sufficiently compact to provide a full, consistent cigarette, may not provide a federally compliant product, and/or may include excessive sticks and/or stems that can cause rolling equipment to jam and/or be damaged.

### SUMMARY

Accordingly, provided are improved systems, devices, products, apparatus, and/or methods for preparing hemp for rolling hemp cigarettes, which may provide rolling hemp that is prepared in a more consistent manner, is more compressed to enable air to be drawn through the hemp when lit to burn evenly, is more compact to provide a more full, consistent cigarette, ensures a federally compliant product, and/or reduces or eliminates sticks and/or stems that can cause rolling equipment to jam and/or be damaged.

According to some non-limiting embodiments or aspects, provided is a method including trimming, with a trimming machine, bucked hemp including dried and cured leaves and flowers of hemp plants to generate trimmed hemp; kiefing, with a cryogenic tumbler, the trimmed hemp to generate kiefed hemp; filtering, with at least one filter, the kiefed hemp to generate rolling hemp; and providing the rolling hemp for rolling hemp cigarettes.

According to some non-limiting embodiments or aspects, provided is a system including a trimming machine configured to trim bucked hemp including dried and cured leaves and flowers of hemp plants to generate trimmed hemp; a cryogenic tumbler configured to kief the trimmed hemp to generate kiefed hemp; and at least one filter configured to filter the kiefed hemp to generate rolling hemp for rolling hemp cigarettes.

Further non-limiting embodiments or aspects are set forth in the following numbered clauses:

Clause 1. A method comprising: trimming, with a trimming machine, bucked hemp including dried and cured leaves and flowers of hemp plants to generate trimmed hemp; kiefing, with a cryogenic tumbler, the trimmed hemp to generate kiefed hemp; filtering, with at least one filter, the kiefed hemp to generate rolling hemp; and providing the rolling hemp for rolling hemp cigarettes.

Clause 2. The method of clause 1, further comprising: bucking, with a bucking machine, dried and cured hemp including dried and cured stems, leaves, and flowers of hemp plants to generate the bucked hemp.

Clause 3. The method of clauses 1 or 2, wherein the dried and cured hemp has a moisture content of 12% or less on a dry weight basis.

Clause 4. The method of any of clauses 1-3, wherein the dried and cured hemp has a delta-9 tetrahydrocannabinol concentration of more than 0.3% on a dry weight basis, and wherein the filtered hemp has a delta-9 tetrahydrocannabinol concentration of 0.3% or less on a dry weight basis.

Clause 5. The method of any of clauses 1-4, wherein an amount of time the bucked hemp is trimmed in the trimming machine is adjusted based on at least one of the following: a moisture content of the dried and cured hemp, a strain of the hemp plants included in the dried and cured hemp, or any combination thereof.

Clause 6. The method of any of clauses 1-5, wherein an amount of time the trimmed hemp is kiefed in the cryogenic tumbler is adjusted based on at least one of the following: a moisture content of the dried and cured hemp, a strain of the hemp plants included in the dried and cured hemp, or any combination thereof.

Clause 7. The method of any of clauses 1-6, wherein the at least one filter includes a first filter including a first mesh size, a second filter including a second mesh size, and a third filter including a third mesh size, wherein the first mesh size is greater than the second mesh size and the third mesh size, and wherein the second mesh size is greater than the third mesh size, and wherein filtering the kiefed hemp to generate rolling hemp further includes: filtering, with the first filter, the kiefed hemp to generate first passed hemp that passes through the first filter and first blocked hemp that is blocked from passing through the first filter; filtering, with the second filter, the first passed hemp to generate second passed hemp that passes through the second filter and second blocked hemp that is blocked from passing through the second filter; filtering, with the third filter, the second passed hemp to generate third passed hemp that passes through the third filter and third blocked hemp that is blocked from passing through the third filter; and providing the third blocked hemp as the rolling hemp.

Clause 8. The method of any of clauses 1-7, wherein the first filter includes a number 5 mesh filter, wherein the second filter includes a number 10 mesh filter, and wherein the third filter includes a number 20 mesh filter.

Clause 9. The method of any of clauses 1-8, further comprising: determining, with a moisture sensor, a moisture content of the rolling hemp on a dry weight basis; and hydrating or dehydrating, with a hydrator/dehydrator system, based on the moisture content, the rolling hemp to have a moisture content of 12% or less on a dry weight basis.

Clause 10. The method of any of clauses 1-9, further comprising: rolling, with an automatic cigarette rolling machine, the rolling hemp in the hemp cigarettes.

Clause 11. A system comprising: a trimming machine configured to trim bucked hemp including dried and cured leaves and flowers of hemp plants to generate trimmed hemp; a cryogenic tumbler configured to kief the trimmed hemp to generate kiefed hemp; and at least one filter configured to filter the kiefed hemp to generate rolling hemp for rolling hemp cigarettes.

Clause 12. The system of clause 11, further comprising: a bucking machine configured to buck dried and cured hemp including dried and cured stems, leaves, and flowers of hemp plants to generate the bucked hemp.

Clause 13. The system of clauses 11 or 12, wherein the dried and cured hemp has a moisture content of 12% or less on a dry weight basis.

Clause 14. The system of any of clauses 11-13, wherein the dried and cured hemp has a delta-9 tetrahydrocannabinol concentration of more than 0.3% on a dry weight basis, and wherein the filtered hemp has a delta-9 tetrahydrocannabinol concentration of 0.3% or less on a dry weight basis.

Clause 15. The system of any of clauses 11-14, wherein an amount of time the bucked hemp is trimmed in the trimming machine is adjusted based on at least one of the following: a moisture content of the dried and cured hemp, a strain of the hemp plants included in the dried and cured hemp, or any combination thereof.

Clause 16. The system of any of clauses 11-15, wherein an amount of time the trimmed hemp is kiefed in the cryogenic tumbler is adjusted based on at least one of the following: a moisture content of the dried and cured hemp, a strain of the hemp plants included in the dried and cured hemp, or any combination thereof.

Clause 17. The system of any of clauses 11-16, wherein the at least one filter includes a first filter including a first mesh size, a second filter including a second mesh size, and a third filter including a third mesh size, wherein the first mesh size is greater than the second mesh size and the third mesh size, and wherein the second mesh size is greater than the third mesh size, wherein the first filter is configured to filter the kiefed hemp to generate first passed hemp that passes through the first filter and first blocked hemp that is blocked from passing through the first filter, wherein the second filter is configured to filter the first passed hemp to generate second passed hemp that passes through the second filter and second blocked hemp that is blocked from passing through the second filter, wherein the third filter is configured to filter the second passed hemp to generate third passed hemp that passes through the third filter and third blocked hemp that is blocked from passing through the third filter, and wherein the third blocked hemp is provided as the rolling hemp.

Clause 18. The system of any of clauses 11-17, wherein the first filter includes a number 5 mesh filter, wherein the second filter includes a number 10 mesh filter, and wherein the third filter includes a number 20 mesh filter.

Clause 19. The system of any of clauses 11-18, further comprising: a moisture sensor configured to determine a moisture content of the rolling hemp on a dry weight basis; and a hydrator/dehydrator system configured to hydrate or dehydrate, based on the moisture content, the rolling hemp to have a moisture content of 12% or less on a dry weight basis.

Clause 20. The system of any of clauses 11-19, further comprising: an automatic cigarette rolling machine configured to roll the rolling hemp in the hemp cigarettes.

### BRIEF DESCRIPTION OF THE DRAWINGS

Additional advantages and details are explained in greater detail below with reference to the exemplary embodiments that are illustrated in the accompanying schematic figures, in which:

FIG. 1 is a diagram of non-limiting embodiments or aspects of an environment in which systems, devices, products, apparatus, and/or methods, described herein, can be implemented;

FIG. 2 is a diagram of non-limiting embodiments or aspects of components of one or more devices and/or one or more systems of FIG. 1; and

FIGS. 3A and 3B are a flowchart of non-limiting embodiments or aspects of a process for preparing hemp for rolling hemp cigarettes.

### DETAILED DESCRIPTION

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

For purposes of the description hereinafter, the terms “end,” “upper,” “lower,” “right,” “left,” “vertical,” “horizontal,” “top,” “bottom,” “lateral,” “longitudinal,” and derivatives thereof shall relate to embodiments or aspects as they are oriented in the drawing figures. However, it is to be understood that embodiments or aspects may assume various alternative variations and step sequences, except where expressly specified to the contrary. It is also to be understood that the specific devices and processes illustrated in the attached drawings, and described in the following specification, are simply non-limiting exemplary embodiments or aspects. Hence, specific dimensions and other physical characteristics related to the embodiments or aspects of the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices that are configured to directly or indirectly communicate with or over one or more networks. A computing device may be a mobile or portable computing device, a desktop computer, a server, and/or the like. Furthermore, the term “computer” may refer to any computing device that includes the necessary components to receive, process, and output data, and normally includes a display, a processor, a memory, an input device, and a network interface. A “computing system” may include one or more computing devices or computers. An “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, touchscreen, etc.). Further, multiple computers, e.g., servers, or other computerized devices directly or indirectly communicating in the network environment may constitute a “system” or a “computing system”.

It will be apparent that systems and/or methods, described herein, can be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code, it being understood that software and hardware can be designed to implement the systems and/or methods based on the description herein.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

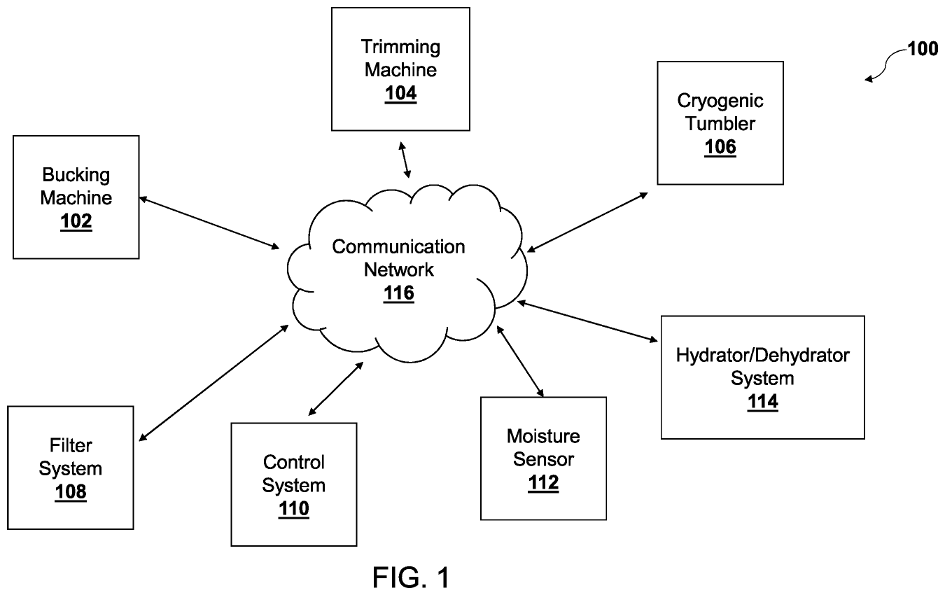

Referring now to FIG. 1, FIG. 1 is a diagram of an example environment 100 in which devices, systems, methods, and/or products described herein, may be implemented. As shown in FIG. 1, environment 100 includes bucking machine 102, trimming machine 104, cryogenic tumbler 106, filter system 108, control system 110, moisture sensor 112, hydrator/dehydrator system 114, and/or communication network 116. Systems and/or devices of environment 100 can interconnect via wired connections, wireless connections, or a combination of wired and wireless connections.

Bucking machine 102 may include one or more devices configured to buck (e.g., de-stem, etc.) dried and cured hemp including dried and cured stems, leaves, and flowers of hemp plants to generate the bucked hemp. In some non-limiting embodiments or aspects, bucking machine 102 may include the T-800 Bucker Machine provided by Intelligent Harvest Systems, the XL Megbucker provided by Centurion Pro Solutions, and/or the like.

Trimming machine 104 may include one or more devices configured to trim hemp (e.g., bucked hemp including dried and cured leaves and flowers of hemp plants, etc.) to generate trimmed hemp. In some non-limiting embodiment or aspects, trimming machine 104 may include a rotary tumbler, such as the Triminator XL dry trimming machine provided by Triminator, the Centurion Pro Trimmer provided by Centurion Pro Solutions, and/or the like.

Cryogenic tumbler 106 (e.g., a medicine wheel tumbler, etc.) may include one or more devices configured to kief hemp (e.g., trimmed hemp, etc.) to generate kiefed hemp. In some non-limiting embodiments or aspects, cryogenic tumbler 106 may include the Medicine Wheel Tumbler by Trim Scene Solutions, Inc.

Filter system 108 may include one or more filters configured to filter hemp (e.g., kiefed hemp, etc.) to generate rolling hemp. In some non-limiting embodiments or aspects, filter system 108 may include a first filter including a first mesh size, a second filter including a second mesh size, and a third filter including a third mesh size, wherein the first mesh size is greater than the second mesh size and the third mesh size, and wherein the second mesh size is greater than the third mesh size. For example, the first filter may be configured to filter the kiefed hemp to generate first passed hemp that passes through the first filter and first blocked hemp that is blocked from passing through the first filter, the second filter may be configured to filter the first passed hemp to generate second passed hemp that passes through the second filter and second blocked hemp that is blocked from passing through the second filter, the third filter may be configured to filter the second passed hemp to generate third passed hemp that passes through the third filter and third blocked hemp that is blocked from passing through the third filter, and the third blocked hemp may be provided as the rolling hemp. As an example, the first filter may include a number 5 mesh filter, the second filter may include a number 10 mesh filter, and the third filter may include a number 20 mesh filter. In some non-limiting embodiments or aspects, the first mesh filter, the second mesh filter, and/or the third mesh filter may include a metal mesh filter (e.g., a stainless steel mesh filter, etc.).

Control system 110 may include one or more devices capable of receiving information and/or data from bucking machine 102, trimming machine 104, cryogenic tumbler 106, filter system 108, moisture sensor 112, and/or hydrator/dehydrator system 114 (e.g., via communication network 116, etc.) and/or communicating information and/or data to bucking machine 102, trimming machine 104, cryogenic tumbler 106, filter system 108, moisture sensor 112, and/or hydrator/dehydrator system 114 (e.g., via communication network 116, etc.). For example, control system 110 may include one or more computing systems including one or more processors (e.g., one or more computing devices, one or more server computers, one or more mobile computing devices, etc.). In some non-limiting embodiments or aspects, control system 110 may be configured to control and/or adjust, based on a moisture content of the dried and cured hemp, a strain of the hemp plants included in the dried and cured hemp, or any combination thereof, one or more processes (e.g., a timing of one or more processes, etc.) of one or more of the following: bucking machine 102, trimming machine 104, cryogenic tumbler 106, filter system 108, control system 110, moisture sensor 112, and/or hydrator/dehydrator system 114, or any combination thereof.

Moisture sensor 112 may include one or more devices configured to determine a moisture content of the rolling hemp on a dry weight basis.

Hydrator/Dehydrator system 114 may include one or more devices configured to hydrate and/or dehydrate hemp (e.g., rolling hemp, etc.).

In some non-limiting embodiments or aspects, environment 100 may further include an automatic cigarette rolling machine (not shown) including one or more devices configured to roll hemp (e.g., rolling hemp, etc.) in hemp cigarettes.

Communication network 116 may include one or more wired and/or wireless networks. For example, communication network 116 may include a cellular network (e.g., a long-term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of systems and devices shown in FIG. 1 is provided as an example. There can be additional systems and/or devices, fewer systems and/or devices, different systems and/or devices, or differently arranged systems and/or devices than those shown in FIG. 1. Furthermore, two or more systems or devices shown in FIG. 1 may be implemented within a single system or a single device, or a single system or a single device shown in FIG. 1 may be implemented as multiple, distributed systems or devices. Additionally, or alternatively, a set of systems or a set of devices (e.g., one or more systems, one or more devices, etc.) of environment 100 may perform one or more functions described as being performed by another set of systems or another set of devices of environment 100.

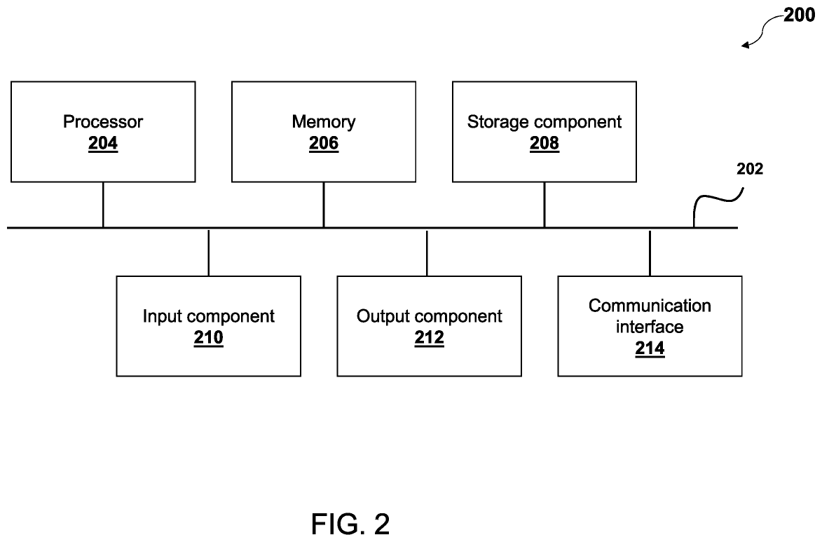

Referring now to FIG. 2, FIG. 2 is a diagram of example components of a device 200. Device 200 may correspond to one or more devices of bucking machine 102, trimming machine 104, cryogenic tumbler 106, filter system 108, control system 110, moisture sensor 112, and/or hydrator/dehydrator system 114. In some non-limiting embodiments or aspects, one or more devices of bucking machine 102, trimming machine 104, cryogenic tumbler 106, filter system 108, control system 110, moisture sensor 112, and/or hydrator/dehydrator system 114 may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, software, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

Memory 206 and/or storage component 208 may include data storage or one or more data structures (e.g., a database, etc.). Device 200 may be capable of receiving information from, storing information in, communicating information to, or searching information stored in the data storage or one or more data structures in memory 206 and/or storage component 208.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

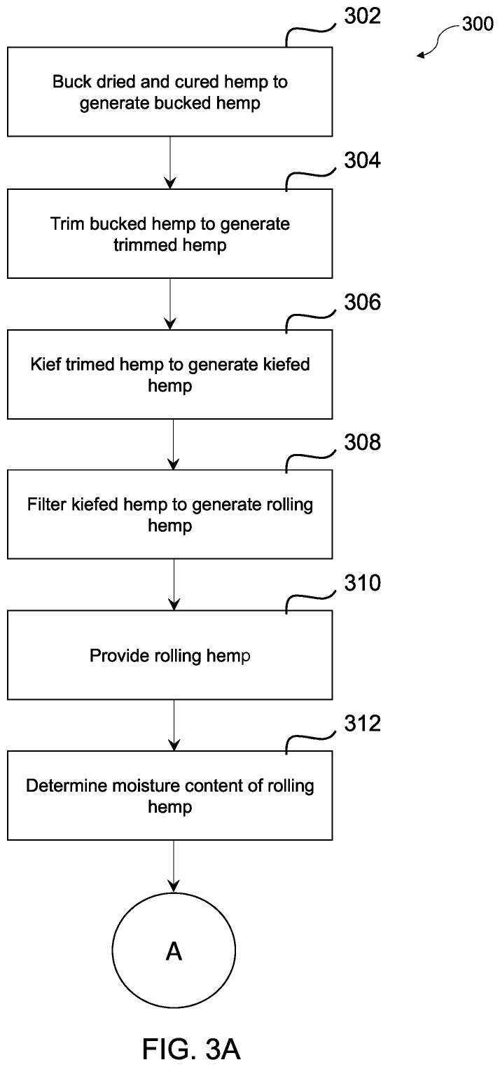

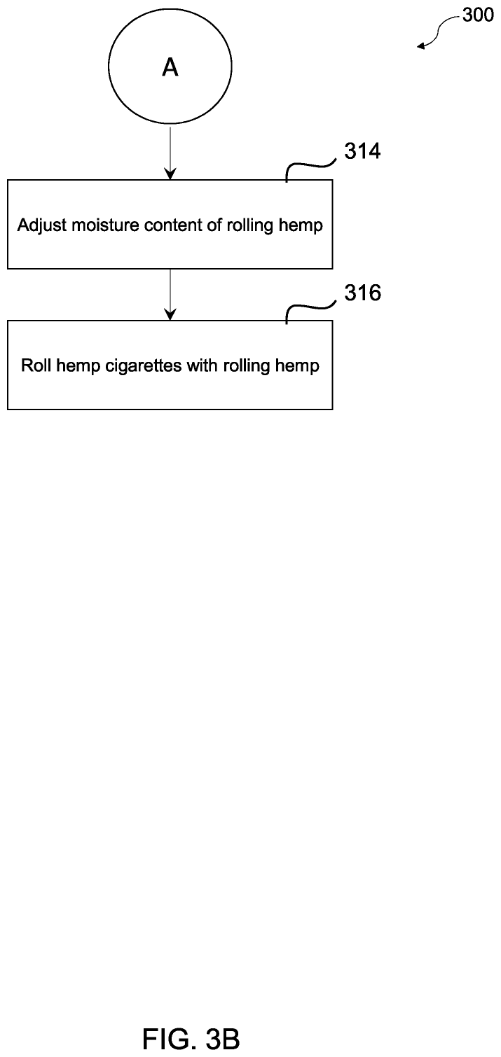

Referring now to FIGS. 3A and 3B, FIGS. 3A and 3B are a flowchart of non-limiting embodiments or aspects of a process 300 for preparing hemp for rolling hemp cigarettes.

As shown in FIG. 3A, at step 302, process 300 includes bucking dried and cured hemp to generate bucked hemp. For example, bucking machine 102 may buck dried and cured hemp including dried and cured stems, leaves, and flowers of hemp plants to generate the bucked hemp. As an example, bucking may include separating leaves and flowers of hemp plants from stems of the hemp plants. For example, bucked hemp may include the separated leaves and flowers of the hemp plants. In such an example, the dried and cured hemp (and/or the bucked hemp) may have a moisture content of 12% or less on a dry weight basis. However, non-limiting embodiments or aspects are not limited thereto, and in some non-limiting embodiments or aspects, the dried and cured hemp may be manually bucked by a human bucker.

As shown in FIG. 3A, at step 304, process 300 includes trimming bucked hemp to generate trimmed hemp. For example, trimming machine 104 may trim the bucked hemp including dried and cured leaves and flowers of hemp plants to generate trimmed hemp. As an example, trimming may shave off excess leaves and shape flowers into standard shapes.

In some non-limiting embodiments or aspects, an amount of time the bucked hemp is trimmed in trimming machine 104 may be adjusted based on at least one of the following: a moisture content of the dried and cured hemp, a strain of the hemp plants included in the dried and cured hemp, or any combination thereof. For example, control system 110 may control trimming machine 104 to adjust the amount of time the bucked hemp is trimmed in trimming machine 104 based on at least one of the following: a moisture content of the dried and cured hemp, a strain of the hemp plants included in the dried and cured hemp, or any combination thereof. As an example, control system 110 may use the moisture content of the dried and cured hemp and/or the strain of the hemp plants included in the dried and cured hemp to access a lookup table to determine the amount of time to trim the bucked hemp in trimming machine 104. However, non-limiting embodiments or aspects are not limited thereto, and in some non-limiting embodiments or aspects, the timing may be manually adjusted.

As shown in FIG. 3A, at step 306, process 300 includes kiefing trimmed hemp to generate kiefed hemp. For example, cryogenic tumbler 106 may kief the trimmed hemp to generate kiefed hemp. As an example, kiefing may separate trichomes, crystals, and/or resin from plant matter (e.g., leaves, flowers, etc.).

In some non-limiting embodiments or aspects, an amount of time the trimmed hemp is kiefed in the cryogenic tumbler 106 is adjusted based on at least one of the following: a moisture content of the dried and cured hemp, a strain of the hemp plants included in the dried and cured hemp, or any combination thereof. For example, control system 110 may control cryogenic tumbler 106 to adjust the amount of time the trimmed hemp is kiefed in cryogenic tumbler 106 based on at least one of the following: a moisture content of the dried and cured hemp, a strain of the hemp plants included in the dried and cured hemp, or any combination thereof. As an example, control system 110 may use the moisture content of the dried and cured hemp and/or the strain of the hemp plants included in the dried and cured hemp to access a lookup table to determine the amount of time to kief the bucked hemp in cryogenic tumbler 106. However, non-limiting embodiments or aspects are not limited thereto, and in some non-limiting embodiments or aspects, the timing may be manually adjusted.

As shown in FIG. 3A, at step 308, process 300 includes filtering kiefed hemp to generate rolling hemp. For example, filter system 108 may filter (e.g., with at least one filter, etc.) the kiefed hemp to generate rolling hemp. As an example, filter system 108 may separate hemp (e.g., kiefed hemp, etc.) that passes through the at least one filter from hemp (e.g., kiefed hemp, etc.) that is blocked from passing through the at least one filter.

In some non-limiting embodiments or aspects, filter system 108 includes a first filter including a first mesh size, a second filter including a second mesh size, and a third filter including a third mesh size. For example, the first mesh size may be greater than the second mesh size and the third mesh size, and the second mesh size may be greater than the third mesh size. As an example, filter system 108 may filter the kiefed hemp to generate rolling hemp by filtering, with the first filter, the kiefed hemp to generate first passed hemp that passes through the first filter and first blocked hemp that is blocked from passing through the first filter; filtering, with the second filter, the first passed hemp to generate second passed hemp that passes through the second filter and second blocked hemp that is blocked from passing through the second filter; filtering, with the third filter, the second passed hemp to generate third passed hemp that passes through the third filter and third blocked hemp that is blocked from passing through the third filter; and providing the third blocked hemp as the rolling hemp. In such an example, the first filter may include a number 5 mesh filter, the second filter may include a number 10 mesh filter, and the third filter may include a number 20 mesh filter.

In some non-limiting embodiments or aspects, the second blocked hemp that is blocked from passing through the second filter may be processed to remove (e.g., by hand, by sorting machine, etc.) sticks and stones from the second blocked hemp to generate cleaned second blocked hemp, and the cleaned second blocked hemp may be provided with the second passed hemp for filtering by the third filter. Accordingly, rolling hemp that is free of sticks, stones, and/or other larger undesirable material, as well as free from smaller material that may pack in a less desirable manner, may be generated.

As shown in FIG. 3A, at step 310, process 300 includes providing rolling hemp. For example, the rolling hemp may be provided for rolling hemp cigarettes.

In some non-limiting embodiments or aspects, the rolling hemp may be manually reviewed by a human reviewer to remove any remaining unwanted material, such as stalk and/or or stem pieces, and/or the like, before the rolling hemp is provided for rolling hemp cigarettes.

In some non-limiting embodiments or aspects, the dried and cured hemp has a delta-9 tetrahydrocannabinol concentration of more than 0.3% on a dry weight basis, and the filtered hemp has a delta-9 tetrahydrocannabinol concentration of 0.3% or less on a dry weight basis.

As shown in FIG. 3A, at step 312, process 300 includes determining a moisture content of rolling hemp. For example, moisture sensor 112 may determine a moisture content of the rolling hemp on a dry weight basis (and/or a moisture content of the dried and cured hemp, the bucked hemp, the trimmed hemp, the kiefed hemp, and/or the like at any stage of the process 300, such as for input to control system 110, etc.).

As shown in FIG. 3B, at step 314, process 300 includes adjusting a moisture content of rolling hemp. For example, hydrator/dehydrator system 114 may hydrate and/or dehydrate, based on the moisture content, the rolling hemp (and/or the dried and cured hemp, the bucked hemp, the trimmed hemp, the kiefed hemp, and/or the like at any stage of the process 300) to have a moisture content of 12% or less on a dry weight basis.

As shown in FIG. 3B, at step 316, process 300 includes rolling hemp cigarettes with rolling hemp. For example, an automatic cigarette rolling machine (not shown) may roll the rolling hemp in hemp cigarettes.

Although embodiments or aspects have been described in detail for the purpose of illustration and description, it is to be understood that such detail is solely for that purpose and that embodiments or aspects are not limited to the disclosed embodiments or aspects, but, on the contrary, are intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, many of these features can be combined in ways not specifically recited in the claims and/or disclosed in the specification. Although each dependent claim listed below may directly depend on only one claim, the disclosure of possible implementations includes each dependent claim in combination with every other claim in the claim set.

What is claimed is:

1. A method comprising:
trimming, with a trimming machine, bucked hemp including dried and cured leaves and flowers of hemp plants to generate trimmed hemp;
kiefing, with a cryogenic tumbler, the trimmed hemp to generate kiefed hemp;
filtering, with at least one filter, the kiefed hemp to generate rolling hemp; and
providing the rolling hemp for rolling hemp cigarettes.

2. The method of claim 1, further comprising:
bucking, with a bucking machine, dried and cured hemp including dried and cured stems, leaves, and flowers of hemp plants to generate the bucked hemp.

3. The method of claim 2, wherein the dried and cured hemp has a moisture content of 12% or less on a dry weight basis.

4. The method of claim 2, wherein the dried and cured hemp has a delta-9 tetrahydrocannabinol concentration of more than 0.3% on a dry weight basis, and wherein the filtered hemp has a delta-9 tetrahydrocannabinol concentration of 0.3% or less on a dry weight basis.

5. The method of claim 2, wherein an amount of time the bucked hemp is trimmed in the trimming machine is adjusted based on at least one of the following: a moisture content of the dried and cured hemp, a strain of the hemp plants included in the dried and cured hemp, or any combination thereof.

6. The method of claim 2, wherein an amount of time the trimmed hemp is kiefed in the cryogenic tumbler is adjusted based on at least one of the following: a moisture content of the dried and cured hemp, a strain of the hemp plants included in the dried and cured hemp, or any combination thereof.

7. The method of claim 1, wherein the at least one filter includes a first filter including a first mesh size, a second filter including a second mesh size, and a third filter including a third mesh size, wherein the first mesh size is greater than the second mesh size and the third mesh size, and wherein the second mesh size is greater than the third mesh size, and wherein filtering the kiefed hemp to generate rolling hemp further includes:
filtering, with the first filter, the kiefed hemp to generate first passed hemp that passes through the first filter and first blocked hemp that is blocked from passing through the first filter;
filtering, with the second filter, the first passed hemp to generate second passed hemp that passes through the second filter and second blocked hemp that is blocked from passing through the second filter;
filtering, with the third filter, the second passed hemp to generate third passed hemp that passes through the third filter and third blocked hemp that is blocked from passing through the third filter; and
providing the third blocked hemp as the rolling hemp.

8. The method of claim 7, wherein the first filter includes a number 5 mesh filter, wherein the second filter includes a number 10 mesh filter, and wherein the third filter includes a number 20 mesh filter.

9. The method of claim 7, further comprising:
determining, with a moisture sensor, a moisture content of the rolling hemp on a dry weight basis; and
hydrating or dehydrating, with a hydrator/dehydrator system, based on the moisture content, the rolling hemp to have a moisture content of 12% or less on a dry weight basis.

10. The method of claim 1, further comprising:
rolling, with an automatic cigarette rolling machine, the rolling hemp in the hemp cigarettes.

11. A system comprising:
a trimming machine configured to trim bucked hemp including dried and cured leaves and flowers of hemp plants to generate trimmed hemp;
a cryogenic tumbler configured to kief the trimmed hemp to generate kiefed hemp; and
at least one filter configured to filter the kiefed hemp to generate rolling hemp for rolling hemp cigarettes.

12. The system of claim 11, further comprising:
a bucking machine configured to buck dried and cured hemp including dried and cured stems, leaves, and flowers of hemp plants to generate the bucked hemp.

13. The system of claim 12, wherein the dried and cured hemp has a moisture content of 12% or less on a dry weight basis.

14. The system of claim 12, wherein the dried and cured hemp has a delta-9 tetrahydrocannabinol concentration of more than 0.3% on a dry weight basis, and wherein the filtered hemp has a delta-9 tetrahydrocannabinol concentration of 0.3% or less on a dry weight basis.

15. The system of claim 12, wherein an amount of time the bucked hemp is trimmed in the trimming machine is adjusted based on at least one of the following: a moisture content of the dried and cured hemp, a strain of the hemp plants included in the dried and cured hemp, or any combination thereof.

16. The system of claim 12, wherein an amount of time the trimmed hemp is kiefed in the cryogenic tumbler is adjusted based on at least one of the following: a moisture content of the dried and cured hemp, a strain of the hemp plants included in the dried and cured hemp, or any combination thereof.

17. The system of claim 11, wherein the at least one filter includes a first filter including a first mesh size, a second filter including a second mesh size, and a third filter including a third mesh size, wherein the first mesh size is greater than the second mesh size and the third mesh size, and wherein the second mesh size is greater than the third mesh size, wherein the first filter is configured to filter the kiefed hemp to generate first passed hemp that passes through the first filter and first blocked hemp that is blocked from passing through the first filter, wherein the second filter is configured to filter the first passed hemp to generate second passed hemp that passes through the second filter and second blocked hemp that is blocked from passing through the second filter, wherein the third filter is configured to filter the second passed hemp to generate third passed hemp that passes through the third filter and third blocked hemp that is blocked from passing through the third filter, and wherein the third blocked hemp is provided as the rolling hemp.

18. The system of claim 17, wherein the first filter includes a number 5 mesh filter, wherein the second filter includes a number 10 mesh filter, and wherein the third filter includes a number 20 mesh filter.

19. The system of claim 17, further comprising:
a moisture sensor configured to determine a moisture content of the rolling hemp on a dry weight basis; and
a hydrator/dehydrator system configured to hydrate or dehydrate, based on the moisture content, the rolling hemp to have a moisture content of 12% or less on a dry weight basis.

20. The system of claim 11, further comprising:
an automatic cigarette rolling machine configured to roll the rolling hemp in the hemp cigarettes.
